(19) United States
(12) Patent Application Publication
(10) Pub. No.: US 2004/0056126 A1
(43) Pub. Date: Mar. 25, 2004

(54) Method and installation for comminuting scrap material

(75) Inventors: August Van Der Beek, Grevenbroich (DE); Erich Kohl, Meerbusch (DE); Rainer Voss, Leverkusen (DE); Bernhard Kock, Moers (DE)

Correspondence Address: CHRISTINA HILDEBRAND, NORRIS, MCLAUGHLIN & MARCUS, 220 EAST 42ND STREET - 30TH FLOOR, NEW YORK, NY, 10017, US

(73) Assignee: Metso Lindemann, Dusseldorf (DE)

(21) Appl. No.: 10/613,551

(22) Filed: Jul. 2, 2003

Related U.S. Application Data
(63) Continuation of application No. 10/215,415, filed on Aug. 8, 2002.
Application No. 10/215,415 is a continuation of application No. PCT/DE01/04257, filed on Nov. 15, 2001.

(30) Foreign Application Priority Data
Nov. 15, 2000 (DE) 100 56 637.5

(51) Int. Cl. B02C 25/00

(52) U.S. Cl. 241/30; 241/34

(57) ABSTRACT

The invention provides a method and an arrangement for operating a system for comminuting scrap material. The installation includes a supply device (1) for the scrap material to be comminuted, and a comminuting machine (2) with at least one motor-driven (2.3) rotor (2.2) which has comminuting tools (2.2.1) and is horizontally positioned in a housing (2.1) and has an ejection door (2.1.1). The inventive installation also includes drive means for controlling the power and for protecting the installation from scrap material which is difficult to comminute or which cannot be comminuted at all, such as coarse, heavy or hard parts. In order to optimize the comminuting process, the values of the motor output, of the rotation speed of the rotor, of the temperature of the motor and the motor bearings and/or of the height of the scrap material flow (3) supplied to the comminuting machine (2), are inputted in a control device (4) and used to control/regulate the scrap material supply. Technical means (4.5, 4.6, 4.7) are provided in the region of the housing (2.1) for ejecting coarse, heavy or hard parts.

### RELATED APPLICATION

This application is a continuation-in-part of U.S. application Ser. No. 10/215,415 which is incorporated by reference, and which is a continuation application of International application PCT/DE01/04257, filed on Nov. 15, 2001, and which claims priority of German Application 100 56 637.5.

### BACKGROUND OF THE INVENTION

1. Field of Invention

The invention relates to a method and an installation for comminuting scrap material. The installation includes a supply device for the scrap material to be comminuted, a comminution machine which includes at least one motor-driven rotor which is horizontally supported in a housing and has comminution tools and drive means, means for controlling the power and means for protecting the installation from scrap material which is difficult to comminute or cannot be comminuted at all, such as coarse, heavy or hard parts.

2. Description of the Related Art

Comminution machines for comminuting scrap metal, such as wood, bulky refuse and the like, are known in different embodiments and with different operating characteristics, as disclosed in DE-A-28 19 611, EP-B1-0 203 272, EP-B1-0 768 920, EP-B1-0 930 941 and U.S. Pat. No. 5,863,003.

During the actual operation of such machines, in particular when a supply device is arranged upflow, and therefore of an entire installation, there is always the problem of achieving the projected parameters for the comminution output, since the aforedescribed scrap materials contain certain unpredictable fractions which are difficult to comminute or cannot be comminuted at all.

### SUMMARY OF THE INVENTION

It is therefore an object of the invention to provide a method and an installation whereby the comminution process can be optimized by providing control means and also through modifications of the apparatus.

According to the method of the invention for operating an installation for comminuting scrap material, an installation is provided which comprises a supply device for the scrap material to be comminuted, a comminution machine with at least one motor-driven rotor, which is horizontally supported in a housing having an ejection door and which includes comminution tools and a drive, a power controller and means for protecting the installation from scrap material that is difficult to comminute or cannot be comminuted at all, such as coarse, heavy or hard parts. The method includes obtaining values of the motor output, the rotation speed of the rotor, the motor temperature and motor bearing temperature and/or the height of the scrap material flow supplied to the comminution machine is inputted in a control device and used by the control device for controlling/regulating the supply of the scrap material. Further, the method includes technical means, for example, measuring elements, a vibration sensor, and a pressure sensor, provided in the region of the housing, are used for ejecting the coarse, heavy or hard parts. Further, for regulating the comminution process, at least one mechanical adjusting element is used in the housing for changing the geometry of the interior space of the housing. Also, the values inputted in the control device, are the vibration values of the comminution machine, from which the parameters vibration amplitude as a function of the frequency and time and/or a recognized vibration pattern are evaluated and used for recognizing scrap material that is difficult to comminute or cannot be comminuted at all and for controlling an ejection of coarse, heavy or hard parts as well as for interrupting and starting the supply of the scrap material. Further, the values representing an increase of the pressure against the ejection door in the housing are inputted in the control device, evaluated and used for recognizing scrap material that is difficult to comminute or cannot be comminuted at all and for controlling an ejection of coarse, heavy or hard parts as well as for interrupting and starting the supply of the scrap material. Values of the motor temperature and motor bearing temperature, the motor output, the rotor rotation speed and/or the height (h) of the scrap material flow supplied to the comminution machine is used by the control device for controlling the speed of a supply belt and a forced loading, respectively, for the scrap material.

The use of software for an operation monitoring system with the functions control/regulation of the supply of the scrap material based on measured values for the control device of the motor output, the rotor rotation speed, the motor temperature and motor bearing temperature and/or the height (h) of the scrap material flow supplied to the comminution machine, control of the ejection of coarse, heavy or hard parts as well as regulation of the supply of the scrap material from the values measured for the control device on the comminution machine, and regulating the comminution process in the housing by way of a mechanical adjusting element for changing the geometry of the interior space of the housing.

The invention also provides for an assembly or installation for operating an installation for comminuting scrap material, which includes a supply device, a comminution machine with at least one rotor, which is driven by a motor and horizontally supported in a housing having a material inlet and an material outlet, and which includes comminution tools and drive means and control means and means for protecting the installation as well as an ejection door for ejecting coarse, heavy or hard parts, having a control device for controlling/regulating the supply device and at least one measuring element which interacts with the housing or parts thereof, with the control device being connected to the measuring element for ejecting coarse, heavy or hard parts. At least one adjusting element is arranged in the housing for changing the geometry of the interior space of the housing. The supply device includes a supply belt and a forced loading. The control device is connected with a first measurement transducer for measuring the motor output, with a second measurement transducer for measuring the motor temperature, with a third measurement transducer for measuring the motor bearing temperature (T₂) and/or with a fourth measurement transducer for measuring the height (h) of the scrap material flow supplied to the comminution machine, and that at least one connection exists from the control device to the supply device for controlling the speed of the supply device. At least one measuring element is a vibration sensor connected with the control device, wherein the control device is connected with a drive element for controlling the ejection door on the housing. The at least one measuring element may be a pressure sensor connected with the control device (4), wherein the control device is connected with the drive element for controlling the ejection door. The adjusting element for changing the geometry of the interior space in the housing is a component, which provides a slope to a corner dead space located above the ejection door and extending to the upper cover of the housing. The ejection door is supported by at least one element, such as a shear bolt with a rated breaking point, wherein the rated breaking point is sized so that the coarse, heavy or hard parts can pass through the ejection door to the outside as a result of a built-up pressure.

### BRIEF DESCRIPTION OF THE DRAWINGS

In the drawings, wherein like numerals delineate similar elements throughout the several view:

FIG. 1 illustrates a schematic diagram of a comminution installation of the invention;

FIG. 2 illustrates a schematic diagram of an embodiment of the installation of a comminution installation of the invention including controller functions;

FIG. 3 illustrates a logic circuit for the installation together with the parameters determining the process;

FIG. 4 illustrates a schematic diagram of a logic circuit for controlling the ejection door as well as for interrupting and starting the scrap material supply.

### DETAILED DESCRIPTION FOR THE PRESENTLY PREFERRED EMBODIMENT

In the figures, the following reference numerals were used:

| | |
|---|---|
| 1 = | supply device |
| 1.1 = | supply belt |
| 1.2 = | forced loading |
| 2 = | comminution machine |
| 2.1 = | housing |
| 2.1.1 = | ejection door |
| 2.1.1.1 = | drive element |
| 2.1.2 = | adjusting element |
| 2.1.3 = | cornerdead space |
| 2.2 = | rotor |
| 2.2.1 = | comminution tools |
| 2.3 = | motor |
| 2.3.1 = | motor bearing |
| 3 = | scrap material flow |
| 4 = | control device |
| 4.1 = | first measurement transducer |
| 4.2 = | second measurement transducer |
| 4.3 = | third measurement transducer |
| 4.4 = | fourth measurement transducer |
| 4.5 = | measuring element |
| 4.6 = | vibration sensor |
| 4.7 = | pressure sensor |
| n = | rotor rotation speed |
| N = | motor output power |
| T₁ = | motor temperature |
| T₂ = | motor bearing temperature |
| C₁ = | speed of supply belt |
| C₂ = | speeds of forced loading |
| h = | height of supplied scrap material flow |
| t = | time } |
| | pressure gradient |
| ΔP = | pressure difference } |

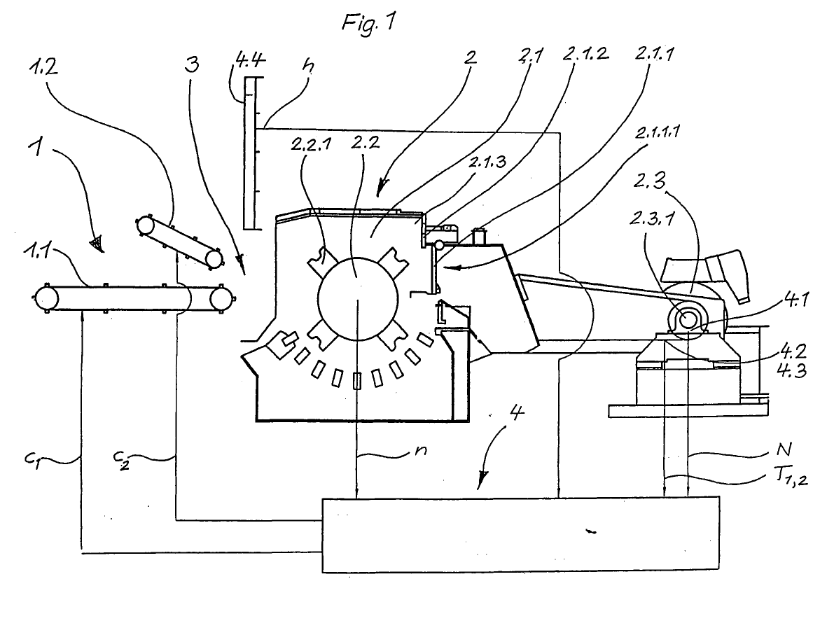

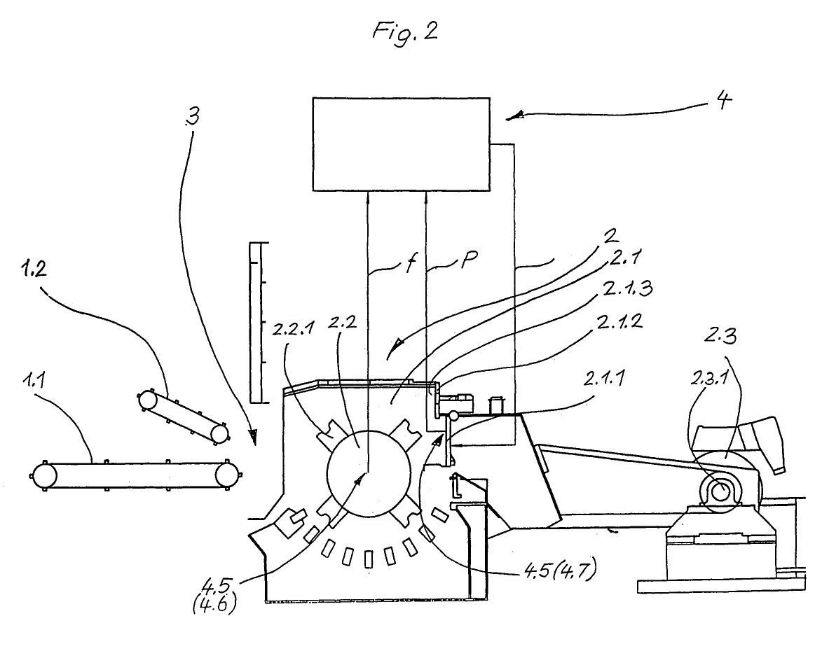

According to FIGS. 1, 2 and 3, the installation for carrying out the method includes a supply device 1, a comminution machine 2 with at least one housing 2.1 having a material inlet and a material outlet, a horizontally supported rotor 2.2 with comminution tools 2.2.1 and driven by a motor 2.3, as well as means for driving, controlling and protecting the installation. The installation further includes an ejection door 2.1.1 for ejecting coarse, heavy and hard parts. A control device 4 is provided for controlling the supply device 1 and at least one measuring element 4.5 operatively connected with the housing 2.1 or with parts of the housing and connected with the control device 4 for ejecting the coarse, heavy and hard parts.

At least one adjusting element 2.1.2 is arranged in the housing 2.1 and adapted to change the geometry of the interior space of the housing 2.1.

The supply device 1 of the installation has a supply belt 1.1 and a forced loading 1.2.

The control device 4 is connected with a first measurement transducer 4.1 for measuring the motor output power N, a second measurement transducer 4.2 for measuring the motor temperature T₁, a third measurement transducer 4.3 for measuring motor bearing temperature T₂ and/or a fourth measurement transducer 4.4 for measuring the height h of the scrap material flow 3 supplied to the comminution machine 2. At least one connection is provided from the control device 4 to the supply device 1 for controlling the speed of the supply device 1.

At least one measurement element 4.5 represents a vibration sensor 4.6 connected with a control device 4, wherein the control device 4 is connected with a drive element 2.1.1.1 for controlling the ejection door 2.1.1 disposed on the housing 2.1.

Alternatively, at least one measurement element 4.5 is implemented as a pressure sensor 4.7 and connected with the control device 4, wherein the control device 4 is also connected with the drive element 2.1.1.1 for controlling the ejection door 2.1.1 disposed on the housing 2.1.

In general, the adjusting element 2.1.2 for changing the geometry of the interior space in the housing 2.1 is implemented as a component which produces a sloping surface in a corner dead space 2.1.3 above the ejection door 2.1.1 with respect to the upper cover of the housing 2.1.

The ejection door 2.1.1 can also be supported against at least one element (not shown), such as a shear bolt with a predetermined breaking point. The predetermined breaking point is hereby sized so that coarse, heavy or hard parts can pass to the outside through the ejection door 2.1.1 when a pressure builds up.

This feature of the construction is a prerequisite for applying the method for protecting the installation against scrap material, such as coarse, heavy or hard parts, that are difficult to comminute or cannot be comminuted at all. For this purpose, values of the motor output power, rotation speed n, motor and motor bearing temperature T₁, T₂ and/or the height of the scrap material flow 3 supplied to the comminution machine 2 are entered into the control device 4 and used by the control device 4 for controlling the supply of the scrap material and the technical means 4.5, 4.6, 4.7 provided in the region of the housing 2.1 for ejecting to coarse, heavy or hard parts.

At least one mechanical adjusting element 2.1.2 capable of controlling the geometry of the interior space of the housing 2.1 is used for controlling the comminution process in the housing 2.1.

One set of value entered into the control device 4 are the vibration values of the comminution machine 2 which are evaluated via the parameters

vibration amplitude as a function of the frequency f and the time t

recognized vibration pattern.

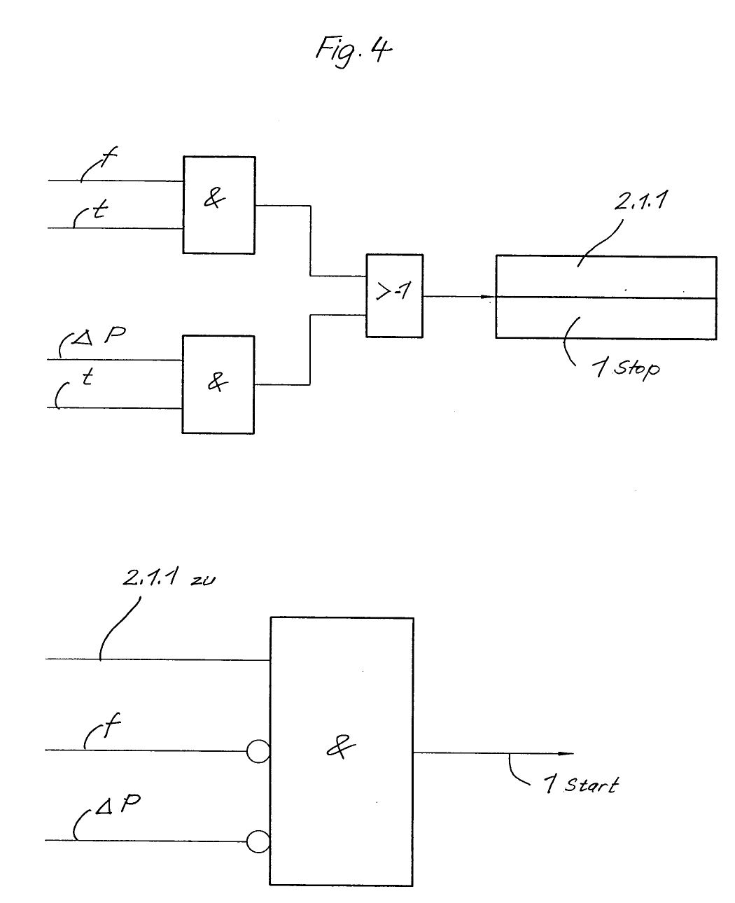

so as to recognize the scrap material that is difficult to comminute or cannot be comminuted at all and for ensuring the control of the ejection of coarse, heavy or hard parts as well as for interrupting and starting the supply of the scrap material (FIG. 4).

FIG. 4 demonstrates how the increase in pressure against the ejection door 2.1.1 in the housing 2.2.1 are entered into the control device 4, processed and used for recognizing the scrap material that is difficult to comminute or cannot be comminuted at all and for controlling the ejection of the coarse, heavy or hard parts as well as for interrupting and starting the supply of the scrap material.

In the method, values of the motor temperature and the motor bearing temperature, the motor output power, the rotation speed and/or the height h of the scrap material flow 3 may also be supplied to the comminution machine 2, supplied via the control device 4 for controlling the speed C₁, C₂ of a supply belt 1.1 and a forced supply 1.2, respectively, for the scrap material.

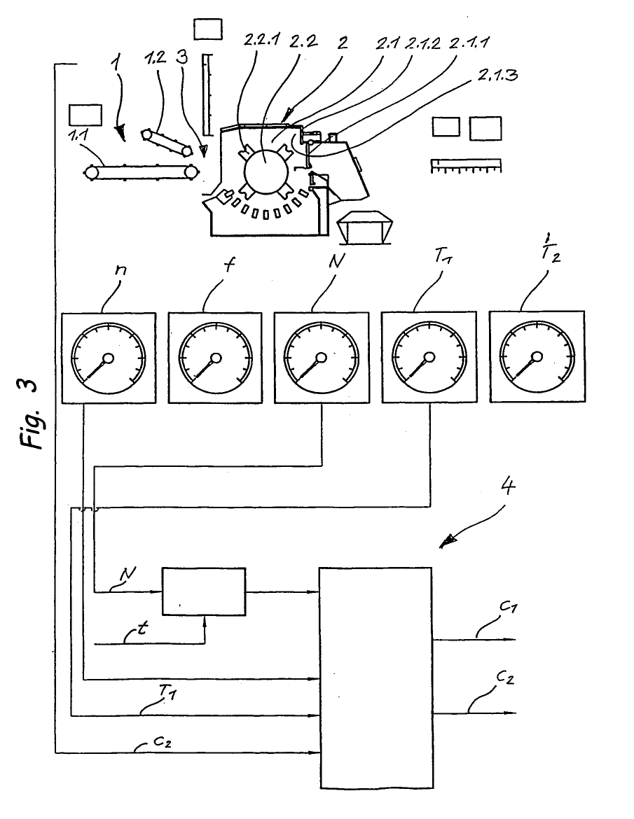

In general, the method for monitoring the operations (see also FIG. 3) can be implemented in software with the following functionality:

control of the supply of the scrap material from measured values of the motor output power N, rotor rotation speed n, motor temperature and motor bearing temperature T₁, T₂ and/or height h of the scrap material flow 3 supplied to the comminution machine for the control devices 4,

control of the ejection of coarse, heavy or hard parts as well as controlling the supply of the scrap material from values measured on the comminution machine 2 for the control device 4, and

control of the comminution process in the housing 2.1 with the mechanical adjusting element 2.1.2 for changing the geometry of the interior space of the housing 2.1.

The invention makes it possible to optimize the comminution output and to protect the installation, even if the aforedescribed scrap materials include unpredictable components that are difficult to comminute or cannot be comminuted at all.

What is claimed is:

1. A method for operating an arrangement for comminuting scrap material, comprising the steps of:
providing a supply device (1) for the scrap material to be comminuted;
providing a comminution machine (2) with at least one motor-driven rotor (2.2) horizontally supported in a housing (2.1) having an ejection door (2.1.1.1) and including comminution tools (2.2.1) and drive means;
providing a power controller and means for protecting the arrangement from scrap coarse, heavy or hard parts;
inputting values of the motor output, rotation speed of the rotor, the motor temperature and motor bearing temperature into a control device (4) and allowing the value to be used by the control device (4) for controlling and regulating the supply of the scrap material;
providing technical means (4.5, 4.6, 4.7) in the region of the housing (2.1) for ejecting the coarse, heavy or hard parts.

2. The method according to claim 1, further comprising a step of
inputting the values of the height of the scrap material flow supplied to the comminution machine (2) into the control device (4) for further controlling and regulating the supply of the scrap material.

3. The method according to claim 2, wherein the regulating the comminution process,
at least one mechanical adjusting element (2.1.2) is used in the housing (2.1) for changing the geometry of the interior space of the housing (2.1).

4. The method according to claim 1, wherein the values inputted in the controller device (4) include vibration values of the comminution machine (2), from which a vibration pattern is evaluated.

5. The method according to claim 4, wherein the vibration pattern comprises vibration amplitude and frequency, used for recognizing coarse, heavy or hard parts in the scrap material and for controlling an ejection and for interrupting and starting the supply of the scrap material.

6. The method according to claim 1, wherein the values representing an increase of the pressure against the ejection door (2.1.1) in the housing (2.1) are inputted in the control device (4), evaluated and used for recognizing coarse, heavy or hard parts in the scrap material and for controlling ejection of coarse, heavy or hard parts and for interrupting and starting the supply of the scrap material.

7. The method according to claim 2, wherein the values of the motor temperature and motor bearing temperature, the motor output, the rotor rotation speed and the height (h) of the scrap material flow (3) supplied to the comminution machine (2) are used by the control device (4) for controlling the speed (C₁, C₂) of a supply belt (1.1) and a forced loading (1.2), respectively, for the scrap material.

8. The method according to claim 2, further utilizing the step of using software for an operation monitoring system for controlling and regulating the supply of the scrap material based on measured values for the control device (4) of the motor output, the rotor rotation speed, the motor temperature and motor bearing temperature and the height (h) of the scrap material flow (3) supplied to the comminution machine (2), and for controlling the ejection of coarse, heavy or hard parts in the scrap material from the values measured for the control device (4) on the comminution machine (2), and for regulating the comminution process in the housing (2.1) by way of a mechanical adjusting element (2.1.2) for changing the geometry of the interior space of the housing (2.1).

9. An arrangement for comminuting scrap material, comprising
a supply device (1),
a comminution machine (2) with at least one rotor (2.2), which is driven by a motor (2.3) and horizontally supported in a housing (2.1) having a material inlet and an material outlet, and which includes comminution tools (2.2.1) and drive means and control means and means for protecting the installation as well as an ejection door (2.1.1.1) for ejecting coarse, heavy or hard parts, wherein a control device (4) for controlling the supply device (1) and at least one measuring element (4.5) which interacts with the housing (2.1); the control device (4) being connected to the measuring element (4.5) for ejecting coarse, heavy or hard parts.

10. The installation according to claim 9, wherein at least one adjusting element (2.1.2) is arranged in the housing (2.1) for changing the geometry of the interior space of the housing (2.1).

11. The installation according to claim 9, wherein the supply device (1) comprises a supply belt (1.1) and a forced loading (1.2).

12. The installation according to claim 9, wherein the control device (4) is connected with a first measurement transducer (4.1) for measuring the motor output (N), with a second measurement transducer (4.2) for measuring the motor temperature (T₁), with a third measurement transducer (4.3) for measuring the motor bearing temperature (T₂) and with a fourth measurement transducer (4.4) for measuring the height (h) of the scrap material flow (3) supplied to the comminution machine (2), and that at least one connection exists from the control device (4) to the supply device (1) for controlling the speed of the supply device (1).

13. The installation according to claim 9, wherein the at least one measuring element (4.5) is a vibration sensor (4.6) connected with the control device (4), wherein the control device (4) is connected with a drive element (2.1.1.1 ) for controlling the ejection door (2.1.1) on the housing (2.1).

14. Installation according to claim 9, wherein at least one measuring element (4.5) is a pressure sensor (4.7) connected with the control device (4), wherein the control device (4) is connected with the drive element (2.1.1.1) for controlling the ejection door (2.1.1).

15. The installation according to claim 9, wherein the adjusting element (2.1.2) for changing the geometry of the interior space in the housing (2.1) is a component, which provides a slope to a corner dead space (2.1.3) located above the ejection door (2.1.1) and extending to the upper cover of the housing (2.1).

16. The installation according to claim 9, wherein the ejection door (2.1.1) is supported by a shear bolt with a rated breaking point, wherein the rated breaking point is sized so that the coarse, heavy or hard parts can pass through the ejection door (2.1.1) to the outside as a result of a built-up pressure.
